(19) United States
(12) Patent Application Publication
(10) Pub. No.: US 2007/0074825 A1
(43) Pub. Date: Apr. 5, 2007

(54) Safety device for door lifts

(75) Inventor: Roberto Zappa, Bergamo (IT)

Correspondence Address: ABELMAN, FRAYNE & SCHWAB, 666 THIRD AVENUE, 10TH FLOOR, NEW YORK, NY, 10017, US

(73) Assignee: SEMATIC ITALIA S.p.A.

(21) Appl. No.: 11/529,646

(22) Filed: Sep. 27, 2006

(30) Foreign Application Priority Data
Oct. 3, 2005 (IT) MI2005U 000343

(51) Int. Cl. E05F 15/20

(52) U.S. Cl. 160/1

(57) ABSTRACT

A safety device for lift doors and sliding doors or shutters in general, electrically powered, specially suited to avoid the danger of having one's fingers being caught in between the lift doors (12-14) and the respective jambs (10) or between the two doors while the latter are opening, of telescopic or central opening type, with glass or crystal (16) with a frame (18) or of a different type, includes at least one electrosensitive strip (20) with middle edge (26) orthogonally developed from the base, vertically extended on at least one of the jambs (10) and/or doors (12) and/or (14) and electrically wired to the cage door control board or to the lift system control board or indirectly connected to e.g. an infrared transmission system.

### SUMMARY

A safety device for lift doors and sliding doors or shutters in general, electrically powered, specially suited to avoid the danger of having one's fingers being caught in between the lift doors (12-14) and the respective jambs (10) or between the two doors while the latter are opening, of telescopic or central opening type, with glass or crystal (16) with a frame (18) or of a different type, includes at least one electrosensitive strip (20) with middle edge (26) orthogonally developed from the base, vertically extended on at least one of the jambs (10) and/or doors (12) and/or (14) and electrically wired to the cage door control board or to the lift system control board or indirectly connected to e.g. an infrared transmission system.

### DESCRIPTION

This invention refers to a safety device for lift doors, sliding doors or shutters in general, being electrically powered. More specifically, this invention refers to a device suited to avoid the danger of having one's fingers being caught in between the lift doors and the jambs, while the doors are opening. It is known that lift systems are traditionally equipped with several safety devices aimed at guaranteeing, especially in emergency conditions, suitable safety levels and at preserving the user's safety. One of these safety devices is aimed at avoiding, while the lift doors are opening, the user's hands or fingers resting on a lift door, being dragged, squashed and caught in between the door and the related side jamb. Such a problem, which is likely to cause serious injuries, is more likely to affect children, who unwittingly tend, for fun or for curiosity, to rest their little hands on the doors while these are moving. Although the space between the doors and the jambs is least, namely a narrow gap, only the children's fingers can easily get into such gap owing to the dragging effect produced by the opening of these doors.

In similar conditions, it is extremely appropriate that the doors opening movement is interrupted as soon as possible. On this matter, safety devices are known which include miniature switches or similar devices, coupled with section bars that tilt under the pressing effect of one's fingers. On an emergency, the section bar pushed by the hand meets a miniature switch, which is connected to the system control unit, and sends a first signal to stop the door opening movement, which is in turn converted into a second door closing signal.

Even if a traditional configuration was set up, such a device involves construction- and assembling-related problems, as it is necessary to pre-arrange special movable section bars and place them in such a way as to allow them to tilt by a given height, through special hinged supports, after being pushed by one's fingers. Even the miniature switches require accuracy as regards their positioning at the assembling stage, since they interact with the section bar and only open or close the circuit if the compression that is exerted upon them has a given intensity, and in the presence of an appropriate travel of the section bar.

All in all, these are expensive solutions, both at the start and in connection with routine maintenance. The object of this invention is to remedy the above-described problems.

More specifically, the object of this invention is to provide a safety device for lift doors, chiefly a device that is suited to avoid the danger of having one's hands or fingers caught in between the opening doors and the related jambs, or between the two doors, which does not require complex parts, such as tilting section bars or miniature switches or similar parts to be provided.

A further object of this invention is to provide a device such as the aforementioned one, suitable to be applied to lift systems or electrically-driven sliding doors in general, in a simple and quick manner.

A further object of this invention is to provide a safety device for lift doors that can guarantee a suitable level of resistance and reliability over time, and also such as to be easily and cheaply manufactured. These and other objects are attained by the safety device for lift doors according to this invention, which is particularly suited to avoid squashing one's fingers between the doors and the related jambs or between the two doors while these are opening, of telescopic or central-opening type, made from glass or crystal with a frame or different, including at least one electrosensitive strip with middle edge orthogonally developed from the base, vertically extended on at least one of the jambs and/or doors and electrically wired to the cage door control board or to the lift system control board.

The construction and functional characteristics of the safety device for lift doors of this invention will become more obvious during the description that follows, where reference is made to the attached drawings, which show a preferred embodiment that is not restrictive in character, and wherein:

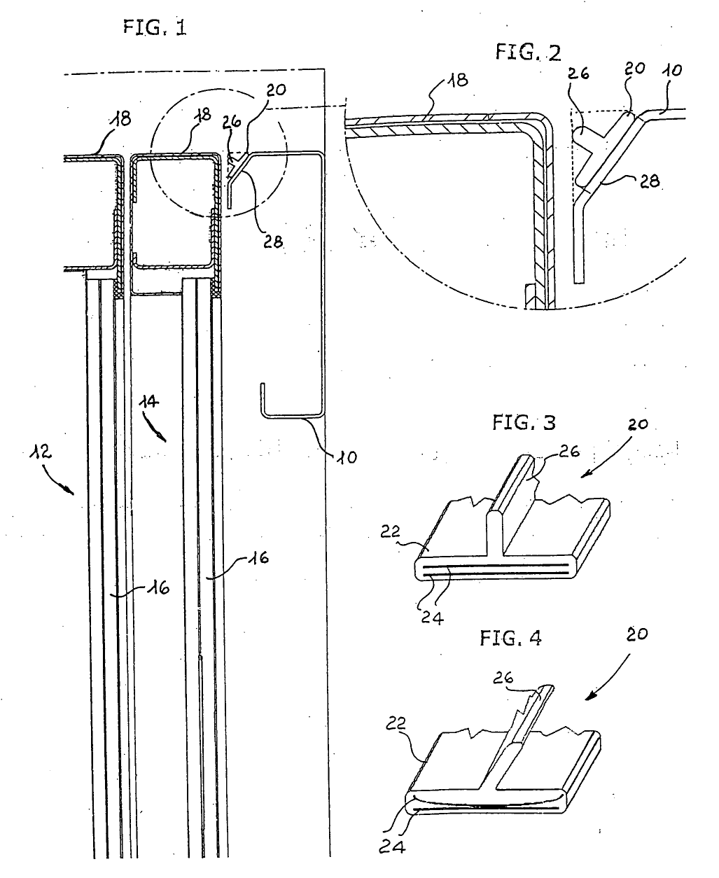

FIG. 1 is a schematic top view of the doors of a lift system equipped with a safety device as per this invention;

FIG. 2 is an enlarged view of a portion of FIG. 1;

FIGS. 3 and 4 are the corresponding schematic cross-sectional views of the safety device of this invention;

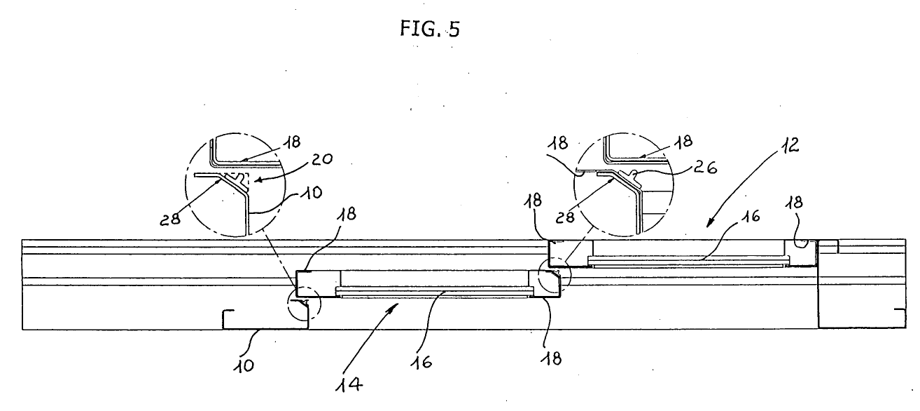

FIG. 5 is a schematic top view of two telescopic doors, forming a half portion of a lift door, while closing, and with two safety devices as per this invention;

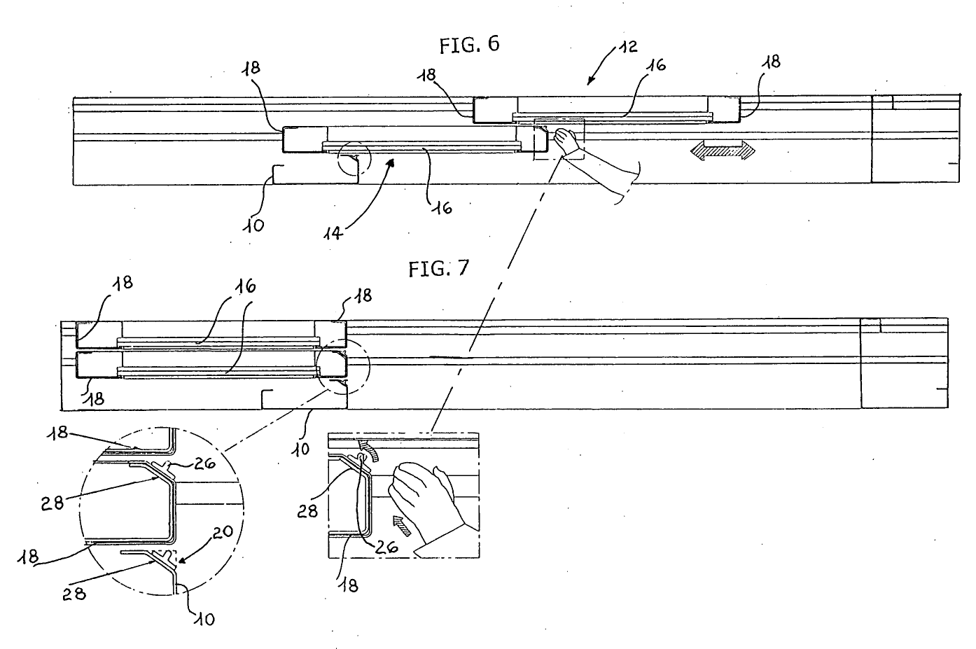

FIG. 6 is a schematic top view of the same telescopic doors as those of the preceding figure, while partially opening;

FIG. 7 is a schematic top view of the same telescopic doors as those of the preceding FIGS. 5 and 6, wide open.

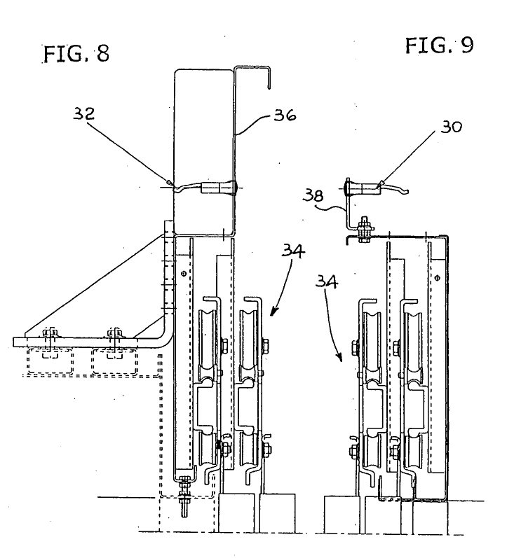

FIGS. 8 and 9 rare as many side schematic views of part of a lift system, with cooperating means with the safety device of this invention being coupled therewith.

With reference to the aforementioned figures, the safety device for lift doors dealt with in this invention is applied to the side jambs 10 of a lift system that includes, for instance, four telescopically opening doors; FIG. 1 shows, for simplicity's sake, two doors only, identified by 12 and 14, made from glass 16, with the respective and traditional frames 18. It shall also be understood that the safety device of this invention can also be applied to lift systems with more than four telescopic doors or with two centrally opening doors, and where the doors are not made from glass or crystal. The safety device of this invention is identified by reference 20 in the figures and includes an electrosensitive strip of known type and manufactured, for example, by the company Grein that markets it under the brand “Tapeswitch”.

This strip, whose partial cross-sectional view is illustrated in FIGS. 3 and 4, includes an outer insulating lining 22 and two foils or conductors 24 extending lengthwise, slightly spaced out and buried or fastened to the inner surfaces of the above lining, which is generally made from PVC.

Electrosensitive strips are arranged vertically along the jambs 10 or along the frame 18 of the door 14, preferably on or close to an apex. These strips, which are fastened to the jambs 10 by using whatever appropriate means, adhesives for instance, are equipped with a middle edge, identified by reference 26, orthogonally developed from the base towards the frame 18 of the door that is opposite the jamb itself, once opened.

In the preferred embodiment, which is not meant to be restrictive, shown in the figures, the electrosensitive strip/s forming the safety device is/are applied to the jambs 10 and to the frame 18 of the door 14 next to a bevel 28 formed on them, this bevel creating, next IS to an apex, an inclined wall whose angle ranges, for instance, between 5° and 90°.

Electrosensitive strips are electrically connected, in a known manner, to the cage door control board or to lift system control panel, directly or indirectly, by means of an infrared transmission system, such as that of the photocells, or a similar type of transmission.

In the event of an infrared transmission system as indicated above, the safety device includes one or more transmitters, referenced with 30 in FIG. 9, and at least one receiver, referenced with 32 in FIG. 8. These FIGS. 8 and 9 illustrate known carriages 34 allowing doors 12 and 14 to slide, located on the upper portion of the doors; FIG. 8 also illustrates a shaped frame 36, belonging to the traditional “operator” assembly, which controls the door movements. According to this embodiment, the mentioned shaped frame is advantageously used to support the receiver 32.

FIG. 9, which also illustrates the carriages 34, shows a bracket 38 acting as a stand for the transmitter 30; this bracket is located just next to each landing floor door. The transmitters 30 are thus located on as many brackets 38 located just next to each landing floor door, whereas the receiver 32 is advantageously one and only, fastened to the said frame 36.

Upon the opening of doors 12, 14, the electrosensitive strip applied to the jambs 10 and/or to one or more doors is met and slightly deformed by the hand that the user may have left in contact with the glass or crystal 16; this deformation, which affects the edge 26, is sufficient to temporarily modify the conformation of the electrosensitive strip, which is elastic, given the PVC lining, and to determine the localized contact of conductors 24, as illustrated in FIG. 4. This contact brings about a short-circuit that interrupts the electrical power supply and is converted in a known manner into a signal sent to the cage doors control board or lift system control panel to reverse the movement, that is to partially close again or stop the doors.

FIG. 5 is a schematic top view of two telescopic doors forming a half portion of a lift door, while closing.

From this figure one can notice that, in this solution, the safety devices 20 are advantageously two, respectively located on the jamb 10 and on the frame 18 of one of the doors, namely the door 14 that slides at a lower speed. In this case, even the frame 18 of this door, in the portion that receives the device 20, is preferably provided with a bevel 28 that is identical or similar to the one made on the jambs 10.

FIGS. 6 and 7 schematically depict the same doors in a condition of partial and total opening, to illustrate all that happens when one's hand comes to be unwillingly caught in between the door 14 and the jamb 10 or between the door 12 and the door 14; the latter condition shows, in the enlarged portion in FIG. 6, the deformation of the edge 26 of the safety device 20.

As one can notice from the foregoing description, the advantages achieved by the invention are obvious.

The safety device for lift doors of this invention is easily installed, guarantees an appropriate functionality and does not require specific hinged supports for similar miniature switches, thus also turning out to be cheaply feasible.

Although the foregoing disclosure of embodiments of the present invention has been described by making special reference to a preferred embodiment which is provided as an example but which is not meant to be exhaustive in character.

All modifications and changes will be obvious to one of ordinary skill in the art in the light and scope of the following claims.

1. A safety device for electronically powered lift doors and/or sliding doors in general, specially suited to avoid the danger of having one's fingers being caught in between the mentioned doors (12-14) and the related jambs (10) or between the two doors during their movement, of telescopic or central opening type, with glass or crystal glass (16), with a frame (18) or of different type, characterized in that they include at least one electrosensitive strip (20), with a middle edge (26) orthogonally developed from the base vertically extended on at least one of the jambs (10) and/or doors (12) and/or (14) and electrically connected to a door opening control device or to the lift system control board.

2. The safety device according to claim 1, characterized in that the electrosensitive strip(s) (20) is/are fastened to the jambs (10) and/or to the doors (12-14) with adhesives or equivalent means and is arranged with its middle edge (26) turned towards the frame (18) of one of the mentioned doors.

3. The safety device according to claim 1, characterized in that the mentioned electrosensitive strip(s) (20) is/are fastened to the jambs (10) and/or to the doors (12-14) next to a bevel (28) formed on them which makes up an inclined wall with an angle ranging between 5° and 90°.

4. The safety device according to claim 1, characterized in that the mentioned electrosensitive strip(s) is/are directly connected to the cages door control board or to the lift system control board or indirectly connected to an infrared transmission system, photocells and similar parts.

5. The safety device according to claim 5, characterized in that the said infrared transmission system comprises one or more transmitters (30) supported by brackets (38) located just next to each lift system landing floor door, in cooperation with at least one receiver (32), tied up to a shaped frame (36) belonging to the “operator” assembly, which controls the door movements.

6. The safety device according to claim 3, characterized in the mentioned electrosensitive strip(s) is/are fastened to the frame/s (18) of the doors (12-14) on which the mentioned bevel is made (28).

7. The safety device according to claim 2, characterized in that the mentioned electrosensitive strip(s) (20) is/are fastened to the jambs (10) and/or to the doors (12-14) next to a bevel (28) formed on them which makes up an inclined wall with an angle ranging between 5° and 90°.

8. The safety device according to claim 2, characterized in that the mentioned electrosensitive strip(s) is/are directly connected to the cages door control board or to the lift system control board or indirectly connected to an infrared transmission system, photocells and similar parts.

9. The safety device according to claim 3, characterized in that the mentioned electrosensitive strip(s) is/are directly connected to the cages door control board or to the lift system control board or indirectly connected to an infrared transmission system, photocells and similar parts.
